(19) United States
(12) Patent Application Publication
(10) Pub. No.: US 2017/0071293 A1
(43) Pub. Date: Mar. 16, 2017

(54) Alerting device

(71) Applicants: Chin-San Hsieh, Tainan City (TW); Chia-Hung Tsai, New Taipei City (TW)

(72) Inventors: Chin-San Hsieh, Tainan City (TW); Chia-Hung Tsai, New Taipei City (TW)

(21) Appl. No.: 15/362,827

(22) Filed: Nov. 29, 2016

(51) Int. Cl. A44B 11/00; G08B 5/00; A44B 11/22

(52) U.S. Cl. CPC A44B 11/005; A44B 11/001; A44B 11/22; G08B 5/004

(57) ABSTRACT

An alerting device in one embodiment is implemented as a buckle of a belt. The alerting device includes an ornamental member; a reflective member disposed rearward of the ornamental member; and a tongue extending rearward of the reflective member. An alerting device in another embodiment includes an ornamental member; a reflective member disposed rearward of the ornamental member; and a clip disposed rearward of the reflective member.

### BACKGROUND OF THE INVENTION

1. Field of the Invention

The invention relates to alerting devices and more particularly such an alerting device implemented as, for example, a buckle of a belt by having a reflective member.

2. Description of Related Art

Conventionally, a belt has a tongue end, a tongue buckle at the other end, and a fabric body interconnecting the both ends. However, the metal tongue buckle may get rusted after a period time of use. Further, the wearer may be hurt by the rusted tongue buckle. Furthermore, the conventional belt is not aesthetic.

Thus, the need for improvement still exists.

### SUMMARY OF THE INVENTION

It is therefore one object of the invention to provide an alerting device comprising an ornamental member; a reflective member disposed rearward of the ornamental member; and a tongue extending rearward of the reflective member.

The above and other objects, features and advantages of the invention will become apparent from the following detailed description taken with the accompanying drawings.

### BRIEF DESCRIPTION OF THE DRAWINGS

FIG. 1 is a perspective view of an alerting device according to a first preferred embodiment of the invention;

FIG. 2 is a side elevation of the alerting device;

FIG. 3 is a perspective view showing the alerting device implemented as a buckle secured to one end of a belt and to be secured to a tongue end of the belt;

FIG. 4 is a perspective view showing the alerting device secured to the tongue end of the belt;

FIG. 5 is a perspective view of an alerting device according to a second preferred embodiment of the invention;

FIG. 6 is a side elevation of the alerting device of FIG. 5;

FIG. 7 is a perspective view showing the alerting device of FIG. 5 secured to an article of clothing; and

FIG. 8 is a perspective view of an alerting device according to a third preferred embodiment of the invention, the alerting device being secured to a windshield of an automobile.

### DETAILED DESCRIPTION OF THE INVENTION

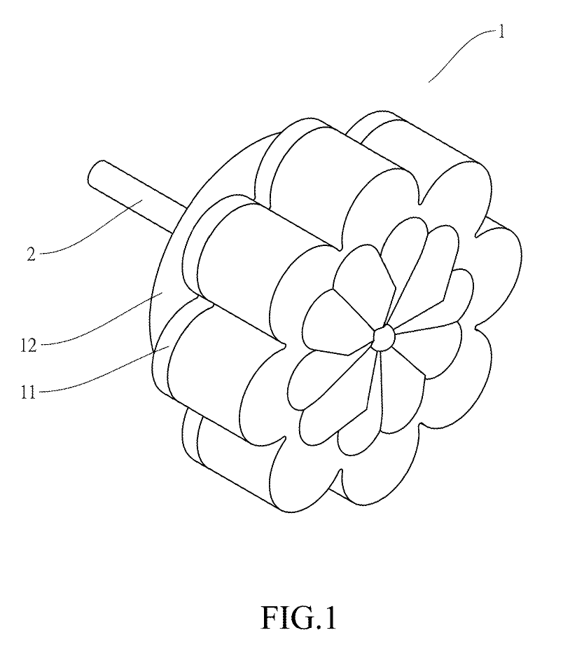

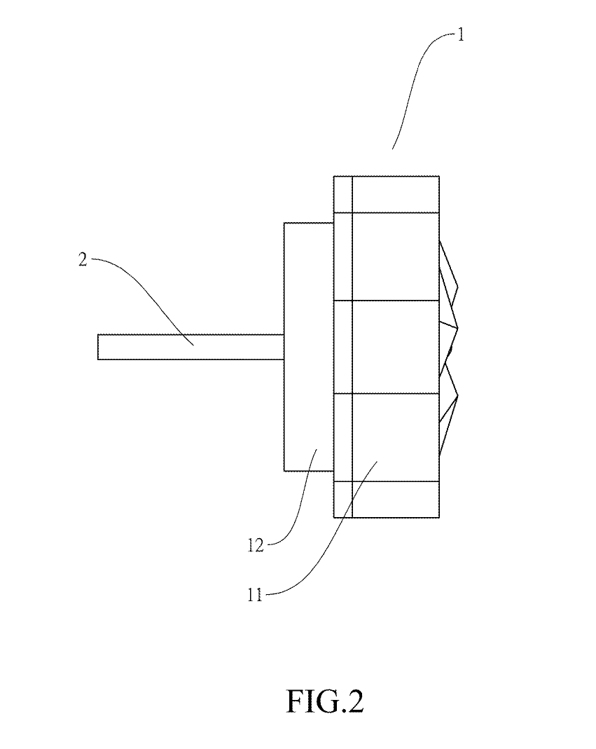

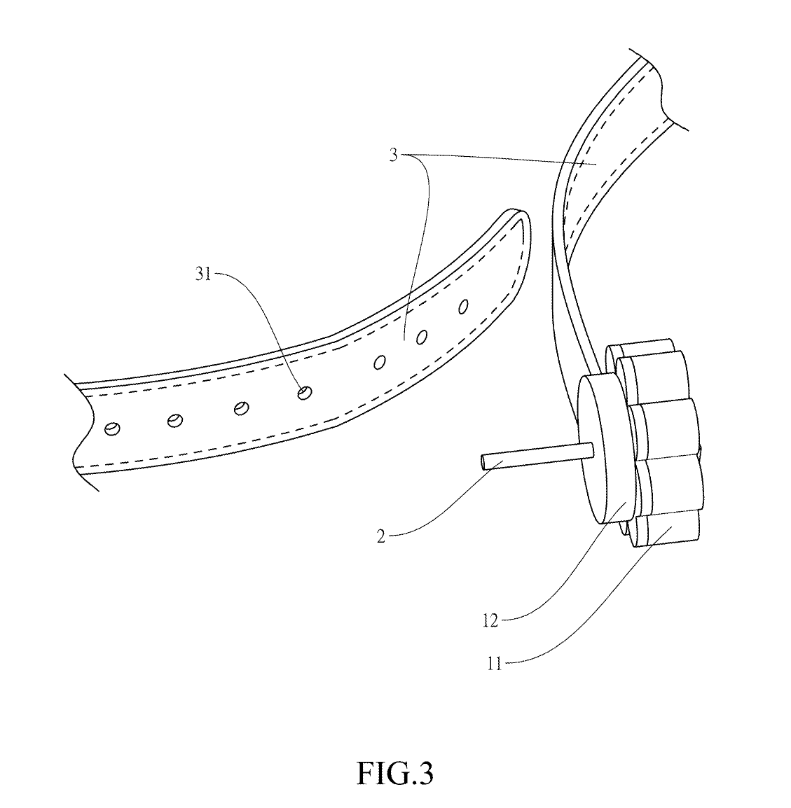

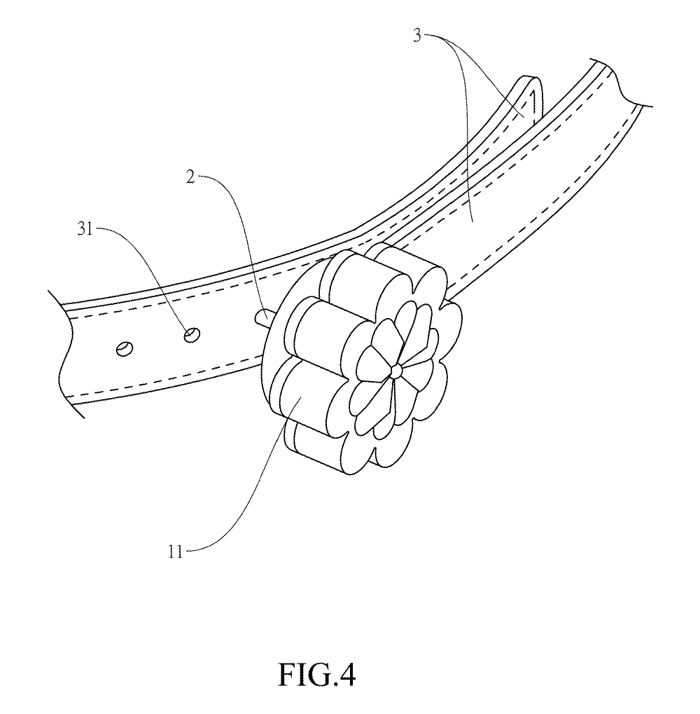

Referring to FIGS. 1 to 4, an alerting device 1 in accordance with a first preferred embodiment of the invention comprises a front ornamental member 11, a rear reflective member 12, and a tongue 2 extending rearward of the reflective member 12 and configured to insert into one of a plurality of holes 31 of a belt 3 to encircle the waist of a wearer.

The ornamental member 11 is, for example, transparent and aesthetic. The reflective member 12 is configured to reflect light for alerting purposes.

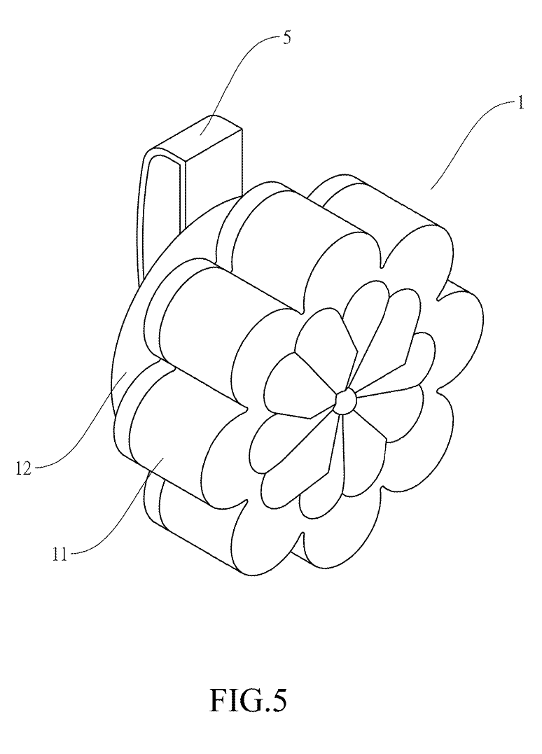

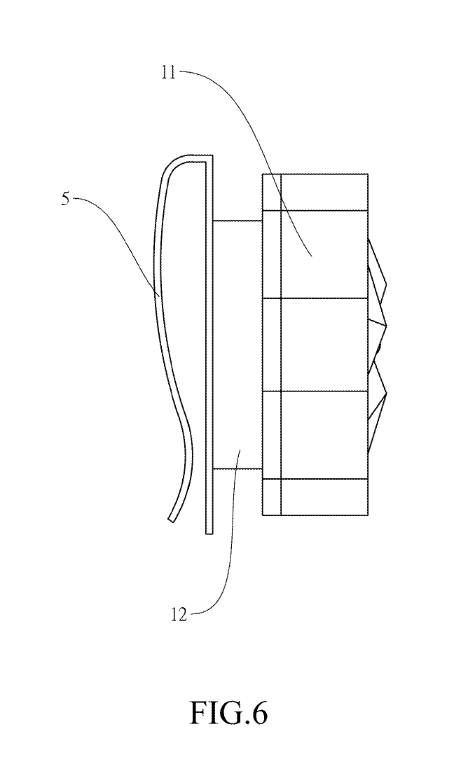

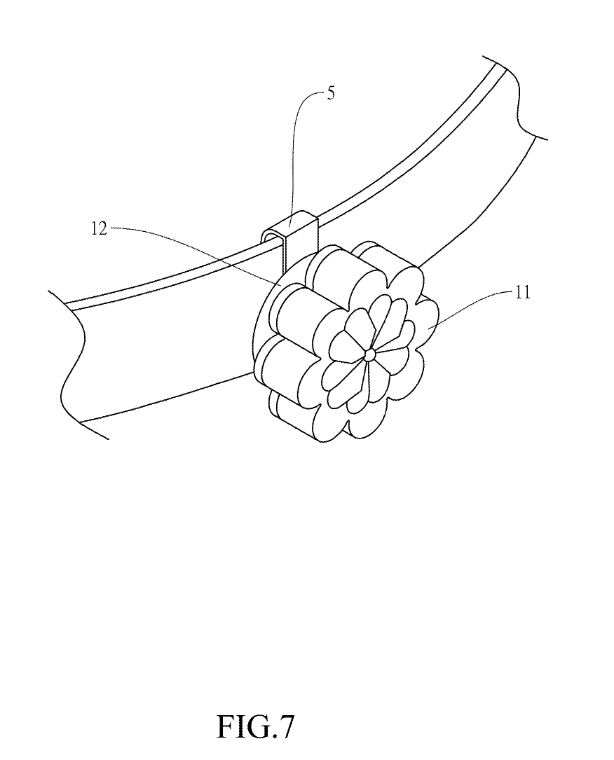

Referring to FIGS. 5 to 7, an alerting device 1 in accordance with a second preferred embodiment of the invention is shown. The characteristics of the second preferred embodiment are substantially the same as that of the first preferred embodiment except the following: The tongue is replaced with a clip 5. The clip 5 is formed on a rear end of the reflective member 12 and is adapted to put on an article of clothing, a waist belt, or the like.

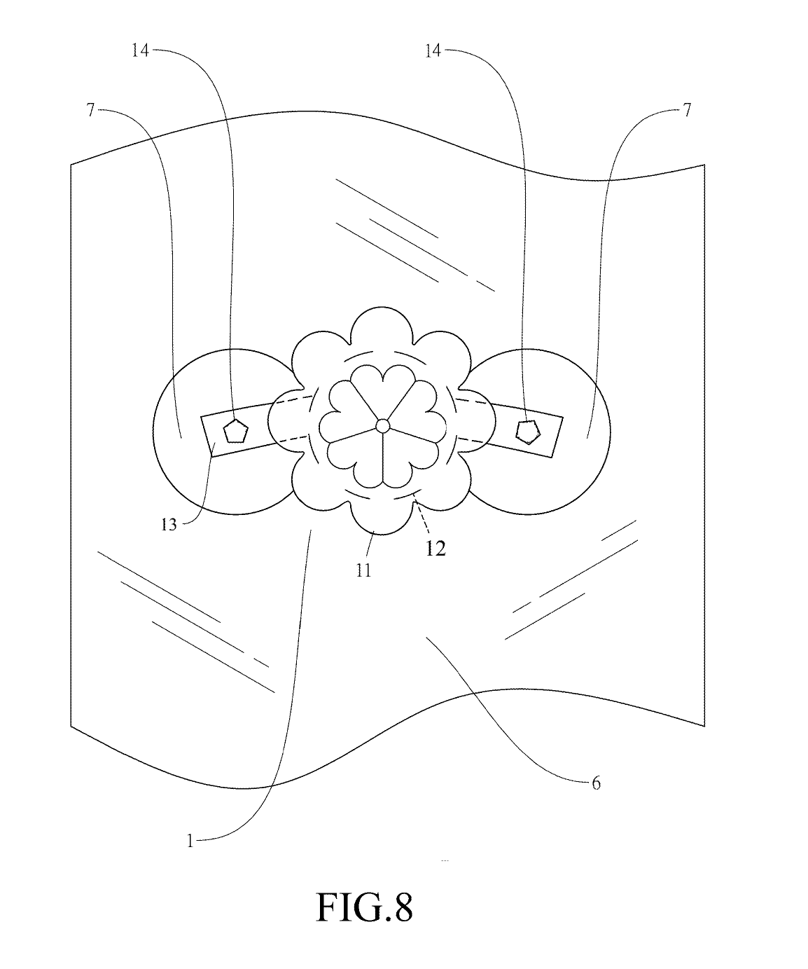

Referring to FIG. 8, an alerting device 1 in accordance with a third preferred embodiment of the invention is shown. The characteristics of the third preferred embodiment are discussed in detail below. The alerting device 1 comprises a front ornamental member 11, a rear reflective member 12, two opposite arms 13 each extending laterally from the reflective member 12, two holes 14 each formed through the arm 13, and two suction cups 7 each secured to the hole 14 and configured to releasably secure to a windshield 6 of an automobile.

While the invention has been described in terms of preferred embodiments, those skilled in the art will recognize that the invention can be practiced with modifications within the spirit and scope of the appended claims.

What is claimed is:

1. An alerting device comprising:
an ornamental member;
a reflective member disposed rearward of the ornamental member; and
a tongue extending rearward of the reflective member.

2. An alerting device comprising:
an ornamental member;
a reflective member disposed rearward of the ornamental member; and
a clip disposed rearward of the reflective member.

3. An alerting device comprising:
an ornamental member;
a reflective member disposed rearward of the ornamental member;
two opposite arms each extending laterally from the reflective member;
two holes each formed through the arm; and
two suction cups each secured to the hole.
